(19) United States
(12) Patent Application Publication
(10) Pub. No.: US 2002/0026325 A1
(43) Pub. Date: Feb. 28, 2002

(54) System, apparatus and method for food management and processing

(76) Inventors: Morio Hirahara, Yokohama (JP); Takuya Kishimoto, Ibaraki (JP); Kanako Fujii, Ibaraki (JP); Masao Isshiki, Tokyo (JP)

Correspondence Address: PILLSBURY WINTHROP LLP, 1600 TYSONS BOULEVARD, MCLEAN, VA, 22102, US

(21) Appl. No.: 09/928,480

(22) Filed: Aug. 14, 2001

(30) Foreign Application Priority Data
Aug. 22, 2000 (JP) 2000-250999

(51) Int. Cl. G06F 7/00; G06F 17/30; G06F 17/60; G06F 17/00; G08B 13/14

(52) U.S. Cl. 705/1; 705/26; 340/572.1; 707/104.1

(57) ABSTRACT

A food management and processing system includes a main data server having a global food data base storing information about food with a food identification code for every food, the information including information about management of the food and information about processing of the food, a user data server having a local food data base storing the information about the food for every user and adapted to access to the main data server via the public communication network, a food storage apparatus having a food managing function and adapted to access via a user communication network to the user data server, and a food processor having an automatic food processing function and adapted to access via the user communication network to the user data server.

### BACKGROUND OF THE INVENTION

1. Field of the invention

This invention relates to a system, apparatus and method for food management and processing which collectively manages food stored and processed at home.

2. Description of the related art

Performance of domestic electric appliances has recently been improved rapidly. With the improvement, the domestic electric appliances having improved convenience or usability and a good environmental adaptability has been developed. Among the domestic electric appliances, food storage apparatus or refrigerators have been rendered large-sized. Users sometimes tend to overlook a pull date of food with increase of stored food. The prior art has proposed a refrigerator which can prevent the users from overlooking the pull date of food. For example, when food is put into a refrigerator, data on the food is input so that the data on the pull date of food is informed of visually or audially during storage of the food.

Furthermore, a microwave oven as a food processor has been proposed in which cooking data is downloaded externally via the Internet so that cooking is executed on the basis of the cooking data. As a result, a volume of cooking data which cannot be stored at the microwave oven side is provided exactly according to the season and food material.

The convenience or usability of the above-described domestic electric appliances has been improved individually. However, an inconvenience results from a composite use of these appliances since the appliances have no relationship between or among themselves. For example, when food stored in a refrigerator is to be heated by a microwave oven, information about the food needs to be input every time of cooking so that cooking data is obtained. Thus, working for inputting the information is troublesome. This results in a reduction of the convenience or usability especially for users who are not accustomed to the appliances.

Even if a type and pull-date of food stored in the refrigerator can be managed, a stored state of the food needs to be displayed for check or the user needs to directly view the interior of a storage compartment of the refrigerator when the user determines what type of food needs to be purchased, on the basis of the management information. Thus, the management information cannot be utilized effectively.

### SUMMARY OF THE INVENTION

Therefore, an object of the present invention is to provide a food management and processing system which can reduce an amount of input operation performed by the user in obtainment of data about food storage and food processing, and can collectively manage food up to a final consumption stage.

The present invention provides a food management and processing system comprising a main data server having a global food data base storing information about food to be managed together with a food identification code for every food, the information about food including information about management of the food and information about processing of the food, the main data server being adapted to be externally connected via a public communication network, a user data server having a local food data base storing the information about the food to be managed for every user, the user data server being adapted to access to the main data server via the public communication network, a food storage apparatus having a food managing function and adapted to access via a user communication network to the user data server, the food storage apparatus including food identification code input means for inputting the identification code affixed to the food, access means for accessing via the main data server to the global food data server so that the information about the food corresponding to the food identification code is downloaded, and data control means accessing via the user data server to the local food data server to receive the food information, and a food processor having an automatic food processing function and adapted to access via the user communication network to the user data server, the food processor including food identification code input means for inputting the identification code affixed to the food, access means for accessing via the main data server to the global food data server so that the information about the food corresponding to the food identification code is downloaded, and data control means accessing via the user data server to the local food data server to receive the food information.

The foregoing system operates as follows. When the user puts food into the food storage apparatus, the food identification code input means inputs a food identification code for the food in the food storage apparatus. The data control means accesses to the local food data base to determine whether data of the food corresponding to the input food identification code is present. When the data is present, the data control means adds data of a new stock to the food information. When the data is absent, the data control means causes the access means to access to the global food data base of the main data server to download the food information of the corresponding food identification code. The food information to which information of the new stock is added is stored on the local food data base. As a result, food can automatically be managed on the basis of management information including various food data such as a pull date of the food stored in the food storage apparatus.

The system operates as follows when food stored in the food storage apparatus or new purchased food is processed by the food processor. When the food identification code input means inputs an identification code of the food in the same manner as described above, the data control means accesses to the local food data base to determine whether data of the food corresponding to the food identification code is present. The data control means downloads food processing information contained in the food information when the food data is present. When the food data is absent, the access means accesses to the global food data base of the main data server so that the data control means downloads information about the food corresponding to the food identification code and stores the information on the local food data base. Consequently, since the processing information is obtained regarding the food corresponding to the food identification code, a proper food processing can be executed with the automatic food processing function.

When the food identification code is input by the user in the above-described case, an inputting operation is performed once regarding a new food and thereafter, food management information and processing information for automatic food processing can be obtained on the basis of the downloaded food information. Consequently, the convenience or usability of the system can be improved with reduction in the complicated inputting operation. Furthermore, the usability of the system can further be improved when the food identification code is automatically read by food identification code input means.

### BRIEF DESCRIPTION OF THE DRAWINGS

Other objects, features and advantages of the present invention will become clear upon reviewing the following description of a preferred embodiment, made with reference to the accompanying drawings, in which:

FIG. 1 is a schematic illustration of the overall system of an embodiment in accordance with the present invention;

FIG. 2 is a block diagram of the system in a refrigerator-freezer;

FIG. 3 is a block diagram of the system in a microwave oven;

FIGS. 4A and 4B illustrate data formats of food information in global and local food data bases respectively;

FIG. 5 is a flowchart showing a food addition program executed by the refrigerator-freezer;

FIG. 6 is a flowchart showing a food deletion program executed by the refrigerator-freezer;

FIG. 7 is a flowchart showing an automatic cooking program executed by the microwave oven.

### DETAILED DESCRIPTION OF A PREFERRED EMBODIMENT

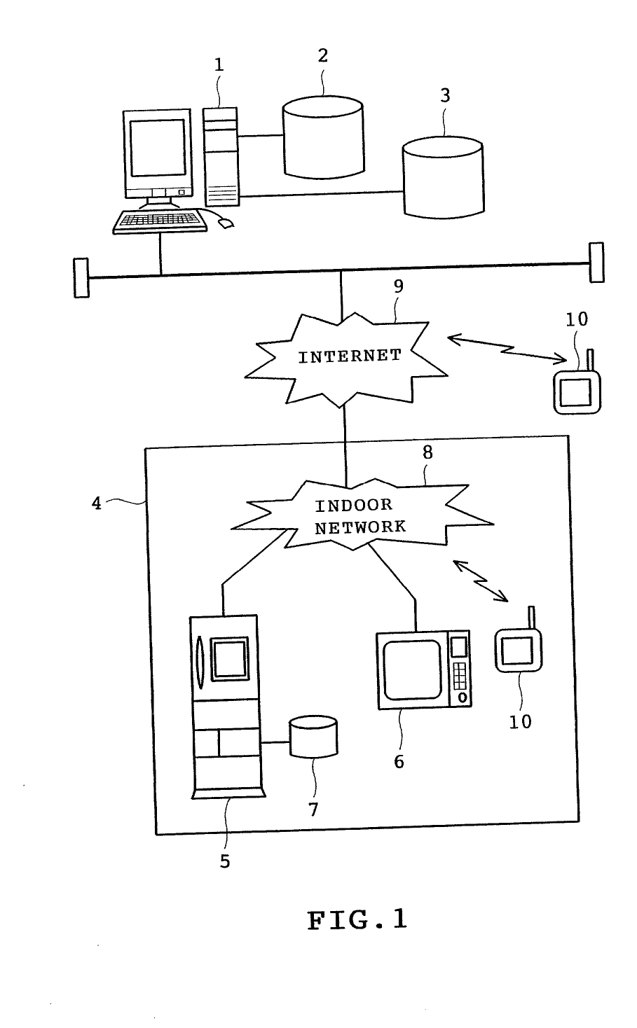

One embodiment in accordance with the invention will be described with reference to the accompanying drawings. In the embodiment, the invention is applied to a system set for every residence. Referring to FIG. 1, the overall system is schematically shown. A main data server 1 generalizes and manages information about foods serving as a constituent of the base of the system. The main data server 1 is provided with a global food data base 2 storing information about all the foods to be managed. The global food data base 2 stores information about foods together with respective food identification codes for every food, the information including information about management of the foods and information about processing of the foods, the main data server being adapted to be externally connected via a public communication network. The main data server 1 is further provided with a personal food management data base 3 which can store and manage information about foods for every user in every residence as will be described later.

In the above-described system, a division as a user is set for every residence so that food used in a residence 4 can be managed. In the residence 4 are provided a refrigerator-freezer 5 serving as a user data server with a gateway function and a microwave oven 6 with an automatic cooking function and an oven function and serving as a food processor. The refrigerator-freezer 5 is provided as a food storage apparatus in the embodiment. However, a refrigerator without a freezing function or a warmer keeping food warm may be provided, instead of the refrigerator-freezer. Furthermore, although the microwave oven 6 is provided as the food processor, another heating apparatus or a refrigerator which processes food by refrigerating the same may be provided, instead.

Furthermore, although foods are managed by the refrigerator-freezer 5 and the microwave oven 6 in the embodiment, an electromagnetic cooking apparatus, an IH (induction heating) rice cooker or a gas cooker with an automatic cooking function may be provided instead. Additionally, other domestic electric apparatus or a personal computer may be used to compose the system for food management.

The refrigerator-freezer 5 is provided with a local food data base 7 storing information about management of foods used in the residence 4. The information about management of foods is read and written via an indoor network 8 serving as a user communication network in the residence 4 on the microwave oven 6 as well as on the refrigerator-freezer 5. The indoor network 8 uses a paired cable such as the Bluetooth or Home Bus System or an Echo Net so that communication between apparatuses is realized. Further, delivery and receipt of information can be executed between the local food data base 7 and the outdoor main data server 1 via the indoor network 8. In this case, the user accesses to the main data server 1 via a telephone line serving as a public communication network or via a well-known Internet 9. On a portable terminal unit 10, the user can also access to the local food data base 7 via the indoor network 8. The portable terminal unit 10 includes a portable personal computer or mobile, peripheral device or portable telephone. Additionally, the user can access to the personal food management data base 3 of the main data server 1 via the Internet 9 when he or she is outside the residence 4.

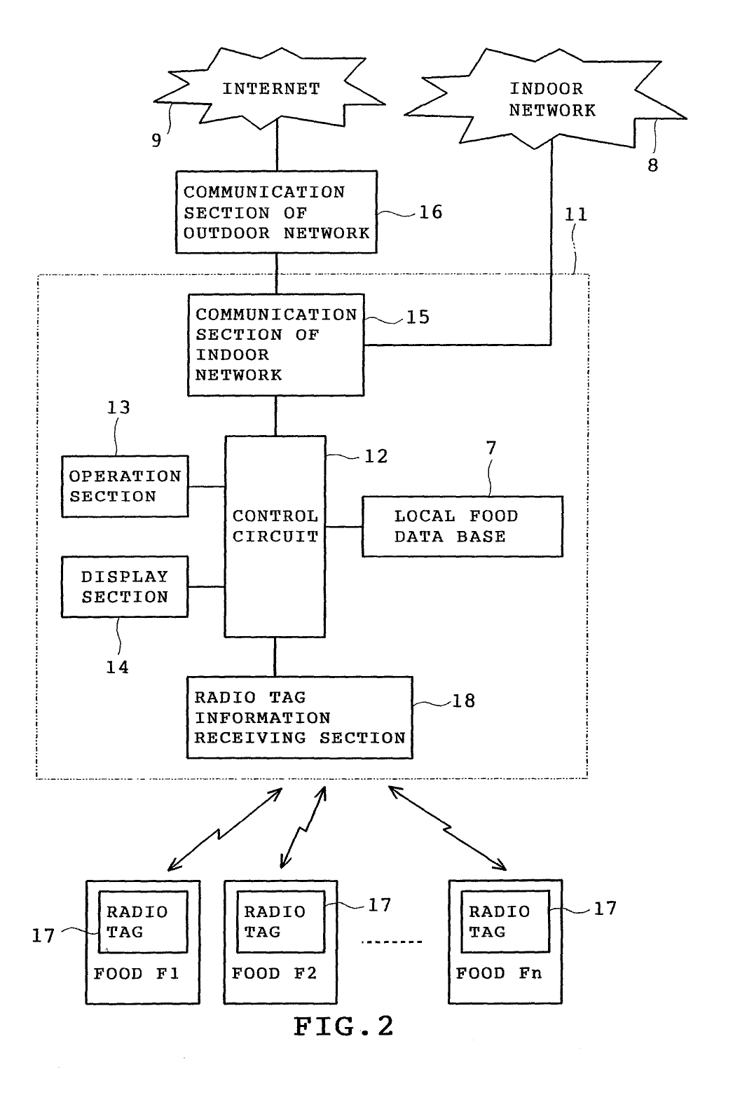

An electrical arrangement for delivery and receipt of information in the refrigerator-freezer 5 will be described with reference to FIG. 2. The refrigerator-freezer 5 includes a control section 11 controlling delivery and receipt of information. The control section 11 comprises a control circuit 12 including a microcomputer, ROM and RAM none of which are shown. The control circuit 12 serves as data control means. An operation section 13 and a display section 14 are provided on the front of a refrigerator body (not shown). The operation section 13 and the display section 14 are connected to the control circuit 12. Information about a food is read out from and written into the local food data base 7 by means of the control circuit 12. An indoor network communication section 15 is connected to the control circuit 12. The user can access to the indoor network 8 via the communication section 15. The communication section 15 is also connected to an outdoor network communication section 16 which is further connected to the Internet 9 serving as the outdoor network. The indoor and outdoor network communication sections 15 and 16 constitute access means.

Furthermore, a radio tag information receiving section 18 is connected to the control circuit 12. The receiving section 18 serves as food identification code input means for reading a food identification code from a radio tag 17. The radio tags 17 are affixed to respective foods F1, F2 and so on. When or while foods are put into or stored in a cold storage compartment or a freezing compartment of the refrigerator-freezer 5, the radio tag information receiving section 18 is operated to automatically carry out communication to read a food identification code, delivering a result to the control circuit 12.

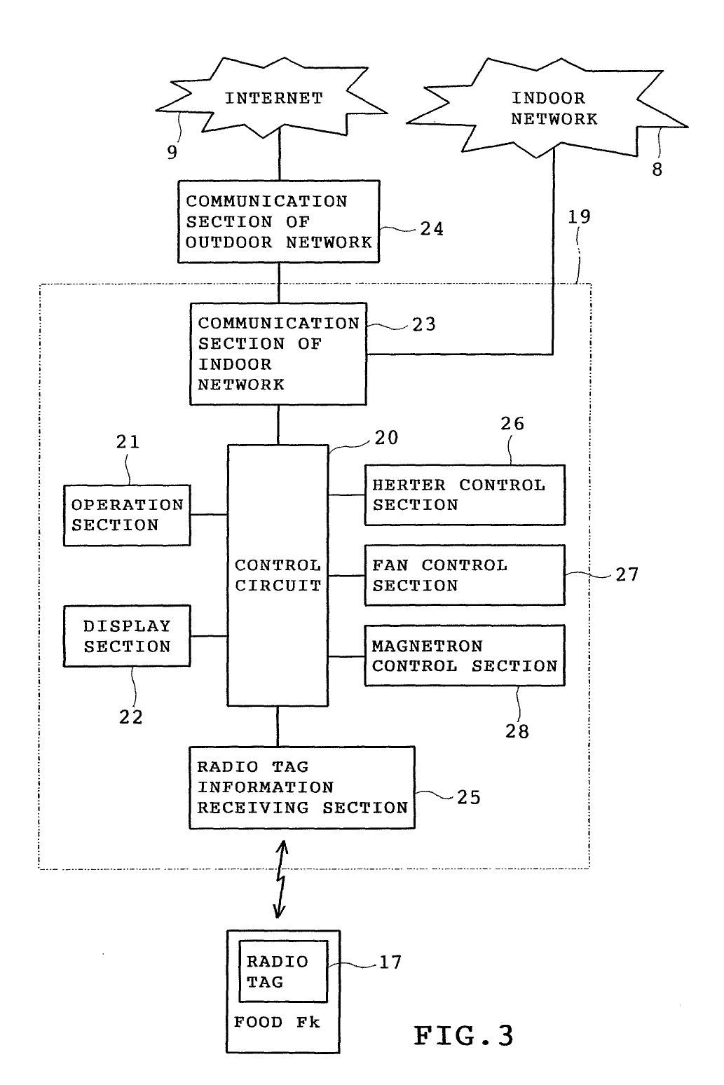

An electrical arrangement for delivery and receipt of information in the microwave oven 6 will be described with reference to FIG. 3. The microwave oven 6 includes a control section 19 controlling delivery and receipt of information. The control section 19 comprises a control circuit 20 including a microcomputer, ROM and RAM none of which are shown. The control circuit 20 serves as data control means. An operation section 21 and a display section 22 are provided on the front of a microwave oven body (not shown). The operation section 21 and the display section 22 are connected to the control circuit 20. An indoor network communication section 23 is connected to the control circuit 20. The user can access to the indoor network 8 via the communication section 23. The communication section 23 is also connected to an outdoor network communication section 24 which is further connected to the Internet 9 serving as the outdoor network. The indoor and outdoor network communication sections 23 and 24 constitute access means.

A radio tag information receiving section 25 is connected to the control circuit 20. The receiving section 25 serves as food identification code input means for reading the food identification code from the radio tag 17. The radio tags 17 are affixed to respective foods Fk and so on. Based on the food identification code read by the receiving section 25, the control circuit 20 obtains cooking information which is used when a food processing such as heating or thawing is executed. A heater control section 26, a fan control section 27 and a magnetron control section 28 are connected to the control circuit 20. A cooking procedure and cooking conditions are determined on the basis of the obtained cooking information for the automatic cooking. Based on the determined cooking procedure and conditions, the control circuit 20 drives a heater, fan and magnetron none of which are shown, thereby executing the heating.

The operation of the system will now be described. The operation of the whole system will first be described. Foods F1 to Fn and Fk include frozen foods for dieting purpose, retort foods and processed foods delivered by a food processing company, for example. These types of foods are distributed with the radio tags 17 being affixed. Foods F1 to Fn and Fk may include other types of foods if it is possible to affix the radio tags 17 to them. The radio tag 17 stores a predetermined food identification code used to identify the food and transmits the food identification code spontaneously or in response to an external read signal. A bar-code or other management codes may store the food identification code, instead of the radio tag 17.

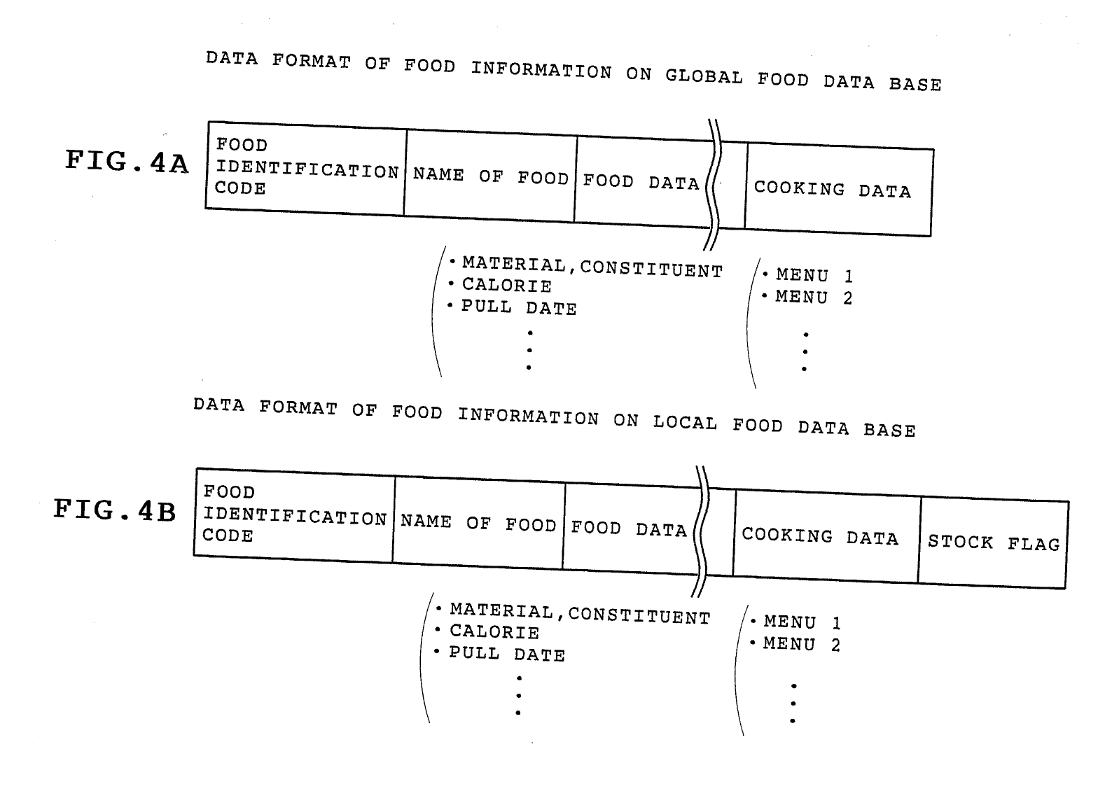

A basic operation of the system for food management will now be described. For example, when purchased by or delivered to the user, a food is put into the refrigerator-freezer 5. The radio tag information receiving section 18 of the refrigerator-freezer 5 receives a food identification code transmitted from the radio tag 17 affixed to the food. A food managing operation is executed on the basis of the received data. The control circuit 12 of the refrigerator-freezer 5 refers to the local food data base 7 to determine whether the received food identification code is new. When the local food data base 7 contains the food identification code, data of the food identification code is copied to be added to the local food data base. When the received food identification code is new, the control circuit 12 accesses via the public telephone line and the Internet 9 to the main data server 1, downloading data of the food in the global food data base 2 and adding the data of the food to the local food data base 7. The global food data base 2 employs a data structure as shown in FIG. 4A and the local food data base 7 employs a data structure as shown in FIG. 4B. The global food data base 2 differs from the local food data base 7 in that information about food in the global data base 2 contains information about a set or reset state of the stock flag. The data structure is composed of a head food identification code, data of a food name, data of food, cooking data, etc. The data of food includes information about materials, composition, calorie, pull date, etc. The cooking data includes information about cooking conditions under which the microwave oven 6 carries out an automatic cooking for the food. The information is stored for every cooking menu.

When a food has been taken out of the refrigerator-freezer 5, receipt of information about the food identification code is ceased, whereby the control circuit 12 recognizes that the food has been taken out of the refrigerator-freezer 5, thereby resetting the stock flag. In the case where the food thus taken out is to be cooked by the microwave oven 6, the radio tag information receiving section 25 receives information of the radio tag 17 affixed to the food when the food is put into a cooking chamber (not shown) of the microwave oven 6. The control circuit 20 of the microwave oven 6 accesses to the local food data base 7 according to the received food identification code to download cooking information for the food. The outdoor network communication section 24 of the control circuit 20 accesses via the Internet 9 to the main data server 1 to download information about the food identification code stored on the global food data base 2 when the control circuit 20 accesses to the local food data base 7 to refer to the food identification code but the corresponding food information is absent. Thus, the cooking information is obtained. Accordingly, when the user selects a desired cooking mode and starts cooking, the control circuit 20 controls the cooking on the basis of an automatic cooking sequence of the downloaded cooking information. More specifically, the control circuit 20 supplies control data to each of the heater, fan and magnetron control sections 26 to 28 so that the heater, fan and magnetron none of which are shown are driven for execution of the cooking. Furthermore, when the user accesses to the main data server 1 on the refrigerator-freezer 5 or microwave oven 6, data stored on the local food data base 7 is uploaded to the personal food management data base 3. As a result, even when the local food data base 7 cannot externally be accessed to, data on the personal food management data base 3 can be downloaded via the main data server 1.

The foregoing can be utilized in the case where information about a food is externally obtained using a portable terminal unit 10, for example. More specifically, the user can get information about the stock of a food inside the residence when he or she operates the portable terminal unit 10 to access to the local food data base 7 on the indoor network 8. Further, the user can get information about the stock of the food outside the residence when he or she operates the portable terminal unit 10 to access to the personal food management data base 3. Consequently, when information about food is downloaded to be stored on the portable terminal unit 10, the user need not confirm food remaining in the refrigerator-freezer 5 and pull date of the food. Accordingly, the user can promptly go out. Further, the information about the food can be displayed on the portable terminal unit 10 while the user is doing his or her shopping. Even when the information about the food is not downloaded to the portable terminal unit 10 at home, the user accesses via the main data server 1 to the personal food management data base 3 so that the information about the food kept in the refrigerator-freezer 5 can be downloaded. Consequently, since the information about the food stored in the residence can reliably be obtained outside, the user can do his or her shopping promptly and exactly.

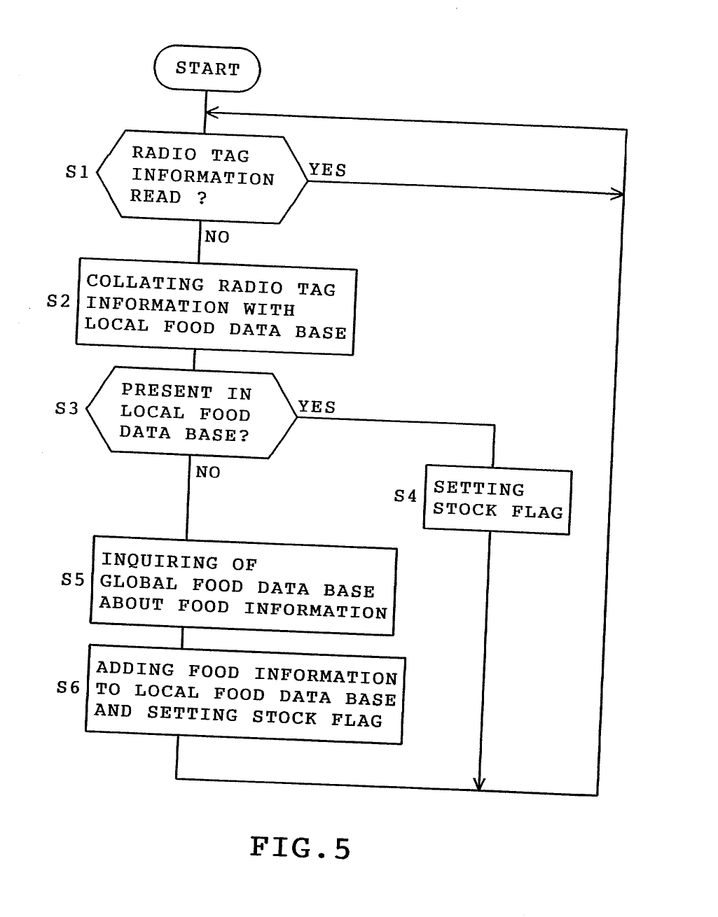

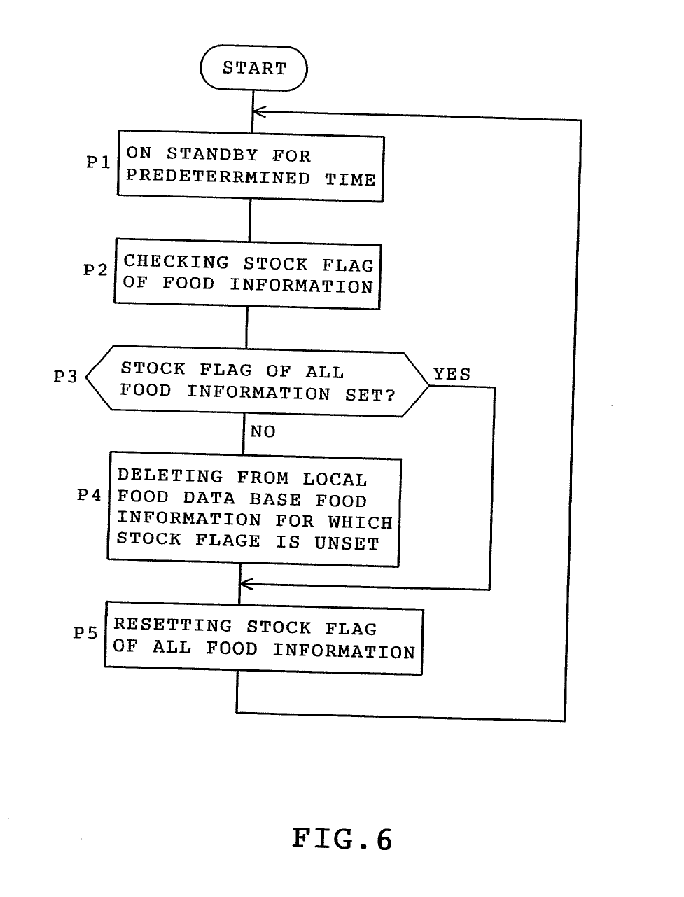

A manner of food management by the control circuit 12 of the refrigerator-freezer 5 will be described with reference to FIGS. 5 and 6. FIG. 5 shows an automatic adding algorithm for adding information about a food to the local food data base 7. The radio tag information receiving section 18 of the control circuit 12 normally monitors foods F1 to Fn accommodated in the cold storage compartment or freezing compartment neither of which is shown, thereby standing ready for receiving radio tag information or a food identification code from the radio tag 17 (step SI). Upon receipt of the food identification code, the control circuit 12 advances to step S2 to collate the read food identification code with data on the local food data base 7. When the read code is present in the data on the data base 7, the control circuit 12 sets the stock flag of information about the corresponding food (step S4), thereafter returning to step Si.

On the other hand, when the information about the food corresponding to the read code is absent in the data on the data base 7, the control circuit 12 determines that the food has been newly added. The outdoor network communication section 16 of the control circuit 12 then accesses via the public communication line and the Internet 9 to the global food data base 2 of the main data server 1. The control circuit 12 inquires the food information corresponding to the read food identification code (step S5), downloading the food information to add the same to the local food data base 7 and setting the stock flag (step S6).

The stock is normally managed on the basis of the radio tag information with respect to the stored foods F1 to Fn. When a new food is put into the cold storage or freezing compartment, information about the food is downloaded to be added to the local food data base 7. Further, when a food with the same food identification code as an already stored food is put into the refrigerator-freezer 5, these foods differ from each other in a time interval of information communication of the radio tag and accordingly, discrepancy between these foods can be determined. Consequently, the control circuit 12 can determine how many foods of the same type are stored in the refrigerator-freezer 5 and manage these foods individually.

Deletion of information about a food from the local food data base 7 will now be described with reference to FIG. 6 showing an automatic deleting algorithm. In the automatic deleting algorithm, the control circuit 12 resets the stock flag with respect to the food information on the local food data base 7 at a predetermined time interval, thereafter standing ready for a predetermined time (step PI). During a standby period, the control circuit 12 carries out the automatic adding program as shown in FIG. 5 to set the stock flag with respect to the food stored in the refrigerator-freezer 5. The aforesaid predetermined time interval needs to be rendered longer than a time required for the control circuit 12 to recognize the radio tag information with respect to all the foods stored in the refrigerator-freezer 5. Thereafter, the control circuit 12 accesses to the local food data base 7 to check the stock flag (step P2). When the stock flag is not set with respect to all the food information (NO at step P3), the control circuit 12 deletes the information about the food for which the stock flag is not set (step P4).

Subsequently, the control circuit 12 resets all the stock flags with respect to the information about the food stored on the local food data base 7 in order to carry out the automatic addition of food as described above (step P5), thereafter returning to step P1. When determining in the affirmative at step P3, the control circuit 12 executes step P5 and then returns to step P1. Thus, in the case where food is added or used (consumed), addition or consumption is recognized such that the information about the food is added or deleted when the stock flag of the information about the food stored on the local food data base 7 is automatically set or reset. Consequently, an exact information about the food in the refrigerator-freezer 5 can be grasped. In the above-described manner, all the determination is made at the refrigerator-freezer 5 side when the food information is deleted. However, regarding the information about the food with the stock flag being reset, the use or execution of automatic cooking at the microwave oven 6 side may be determined at the refrigerator-freezer 5 side and the information about the food on the local food data base 7 may be deleted.

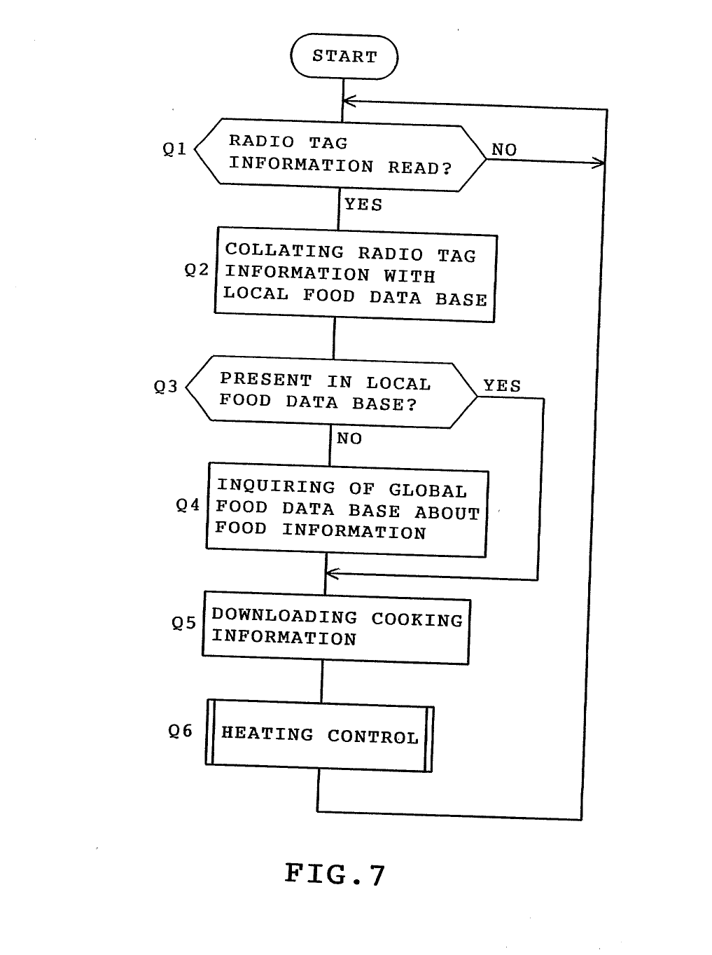

An automatic operation of the microwave oven 6 will now be described with reference to FIG. 7. The radio tag information receiving section 25 of the control circuit 20 normally monitors foods accommodated in the cold storage compartment or freezing compartment neither of which is shown, thereby standing ready for receiving radio tag information or a food identification code from the radio tag 17 (step Q1). The control circuit 20 advances to step Q2 upon receipt of the food identification code. The indoor network communication section 24 of the control circuit 20 accesses via the indoor network 8 to the local food data base 7 of the refrigerator-freezer 5. The control circuit 20 collates the read food identification code with data on the local food data base 7. When the read code is absent in the data on the data base 7 or when the food is not the one taken out of the refrigerator-freezer 5, the control circuit 20 accesses via the Internet 9 to the global food data base 2 of the main data server 1 in order to get information about the food corresponding to the food identification code (step Q4). The control circuit 20 then downloads cooking information contained in the food information (step Q5).

On the other hand, when determining in the affirmative at step Q3, the control circuit 20 advances to step Q5 to download the cooking information from the information about the food stored on the local food data base 7. As a result, the control circuit 20 obtains an automatic cooking sequence for the food. The display section 22 displays the information about the food. Thereafter, the food is put into a cooking chamber (not shown) of the microwave oven 6 and the user operates the operation section 21 so that the cooking is initiated. The control circuit 20 then executes the heating operation on the basis of data of the automatic cooking sequence in the manner as described above (step Q6). Furthermore, the microwave oven 6 deletes the information about the food stored on the local food data base 7 or resets the stock flag when the automatic cooking is initiated or completed. Consequently, the accuracy in the management of food stock can be improved.

In a modified form, the food identification code may be affixed as bar-code information to a package or a display portion of food, instead of the radio tag 17. In this case, the food identification code is read by the food identification code input means when food is put into the cold storage or freezing compartment of the refrigerator-freezer 5, whereby stock of food can be managed.

There are some types of foods to which food identification codes cannot be affixed. In this case, food identification codes are previously determined and the user manually inputs the codes. The food to which the predetermined food identification code is affixed can be designated as necessitating a special management.

The cooking information may include data of a plurality of cooking manners for a food. In this case, the user selects desired cooking data for the automatic cooking.

Although the invention is applied to the system including the refrigerator-freezer 5 and the microwave oven 6 in the foregoing embodiment, the invention may be applied to the system including any equipment for processing food. For example, the invention may be applied to a food stocker for storing foods at an ordinary temperature or a wine stocker. Further, the heating apparatus may include hot plates, electromagnetic cooking apparatus, IH (induction heating) rice cookers, and gas cookers with an automatic cooking function. Additionally, the invention may be applied to the case where food is cooked by means of refrigeration in a refrigerator.

The Internet 9 and the public telephone line are used as the public communication networks in the foregoing embodiment. However, only the Internet 9 may be used or means for transmitting and receiving information by radio communication may be used.

Although the refrigerator-freezer 5 serves as the user data server in the foregoing embodiment, an independent user data server may be provided, instead. Provision of the independent user data server can render the food management for every user more reliable.

The residence is regarded as a unit of user in the foregoing embodiment. However, when a plurality of refrigerators are provided in one residence, a refrigerator may be a unit of user. Further, a restaurant or a company may be a unit of user.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. A food management and processing system comprising:
a main data server having a global food data base storing information about food to be managed together with a food identification code for every food, the information about food including information about management of the food and information about processing of the food, the main data server being adapted to be externally connected via a public communication network;
a user data server having a local food data base storing the information about the food to be managed for every user, the user data server being adapted to access to the main data server via the public communication network;
a food storage apparatus having a food managing function and adapted to access via a user communication network to the user data server, the food storage apparatus including food identification code input means for inputting the identification code affixed to the food, access means for accessing via the main data server to the global food data server so that the information about the food corresponding to the food identification code is downloaded, and data control means accessing via the user data server to the local food data server to receive the food information; and
a food processor having an automatic food processing function and adapted to access via the user communication network to the user data server, the food processor including food identification code input means for inputting the identification code affixed to the food, access means for accessing via the main data server to the global food data server so that the information about the food corresponding to the food identification code is downloaded, and data control means accessing via the user data server to the local food data server to receive the food information.

2. A food management and processing system according to claim 1, wherein the food storage apparatus has a function of the user data server.

3. A food management and processing system according to claim 1, wherein the main data server includes a personal food management data base and receives from the user data server the information about the food corresponding to a content stored on the local food data base, thereby storing the received information about the food.

4. A food management and processing system according to claim 3, wherein the main data server accepts an access to the personal food management data base received via the public communication network from a portable terminal unit.

5. A food management and processing system according to claim 3, wherein the user data server accepts an access to the local food data base received via the public communication network from a portable terminal unit.

6. A food management and processing system according to claim 3, further comprising a portable terminal unit adapted to be connected to the public communication network so as to access via the main data server to the personal food management data base.

7. A food management and processing system according to claim 4, wherein the food storage apparatus uploads the information about the food stored on the local food data base to the portable terminal unit.

8. A food management and processing system according to claim 1, wherein the food identification code input means of the food storage apparatus receives the food identification code delivered from a radio tag affixed to the food, and the data control means of the food storage apparatus accesses to the food local data base regarding the food identification code received by the food identification code input means, thereby adding or deleting the information about the food.

9. A food management and processing system according to claim 1, wherein the food identification code input means of the food processor receives the food identification code delivered from a radio tag affixed to the food, and the data control means of the food processor accesses to the local food data base regarding the food identification code received by the food identification code input means to download the information about processing of the food in the information about the food, thereby executing the automatic food processing function on the basis of the information about processing of the food.

10. A food management and processing system according to claim 1, wherein the food identification code input means of the food processor receives the food identification code delivered from a radio tag affixed to the food, and the data control means of the food processor accesses to the global food data base regarding the food identification code received by the food identification code input means to download the information about processing of the food in the information about the food, thereby executing the automatic food processing function on the basis of the information about processing of the food.

11. A food management and processing system according to claim 9, wherein when having executed the automatic food processing, the food processor delivers to the user data server a requirement of deleting the information about management of the food from the local food data base.

12. A main data server comprising:
a global food data base storing information about food to be managed together with a food identification code for every food, the information about food including information about management of the food and information about processing of the food; and
data processing means accepting an access received via a public communication network from a user data server, the data processing means further accepting the information about the food corresponding to the food identification code stored on a global food data base when the information about the food is required to be downloaded, thereby providing the information about the food.

13. A main data server according to claim 12, further comprising a personal food management data base managed for every user and receiving from the user data server the information about the food corresponding to a content stored on the local food data base and storing the same.

14. A main data server according to claim 12, provided with a function of accepting an access from a portable terminal unit to the personal food management data base, the access being received via the public communication network.

15. A food managing method executed by a main data server, comprising:
storing, on a global food data base, information about food to be managed together with a food identification code for every food, the information about the food including information about management of the food and information about processing of the food; and
accepting an access from a user data server, further accepting a requirement for download of the information about the food corresponding to the food identification code stored on the global food data base, and providing the information about the food.

16. A food managing method according to claim 15, further comprising storing, on a personal food management data base managed for every user, the information about the food corresponding to a content stored on the local food data base provided by the user data server.

17. A food managing method according to claim 15, further comprising accepting an access from a portable terminal unit to the personal food management data base, the access being received via a public communication network.

18. A user data server comprising:
a local food data base storing information about food to be managed for every user;
access means for accessing via a public communication network to a main data server; and
data processing means adapted to be accessed via a user communication network from a food storage apparatus or a food processor to receive a requirement for readout of the information about the food stored on the local food data base, thereby accepting the requirement and providing the information about the food.

19. A user data server according to claim 18, having a function of accepting an access from a portable terminal unit to the local food data base, the access being received via the user communication network.

20. A food managing method executed by a user data server, comprising:
storing, on a local food data base managing food for every user, information about food to be managed;
accepting a requirement for an access to a main data server and accessing via a public communication network to the main data server; and
accepting an access from a food storage apparatus or a food processor via a user communication network to receive a requirement for readout of the information about the food stored on the local food data base, thereby providing the information about the food.

21. A food managing method according to claim 20, further comprising accepting an access from a portable terminal unit to the local food data base, the access being received via the user communication network.

22. A food storage apparatus comprising:
food identification code input means for inputting a food identification code affixed to food;
access means for accessing via a main data server to a global food data base and downloading information about food corresponding to the food identification code;
data control means for accessing via a user data server to a local food data base to receive the information about the food; and
food management means for inputting the food identification code affixed to the food stored, by means of the food identification code input means and managing the stored food on the basis of the information about the food obtained by the access means and the data control means.

23. A food storage apparatus according to claim 22, further comprising:
a local food data base storing the information about the food managed for every user;
access means for accessing via a public communication network to the main data server; and
data processing means accessed to via a user communication network by the food storage apparatus or a food processor to receive a requirement for readout of the information about the food stored on the local food data base, thereby accepting the requirement and providing the information about the food.

24. A food storage apparatus according to claim 22, wherein the data processing means has a function of uploading the food information stored on the local food data base in reply to an access by a portable terminal unit.

25. A food storage apparatus according to claim 22, wherein the food identification code input means receives a food identification code delivered from a radio tag affixed to the food, and the data control means accesses to the local food data base to add to or delete from the data base the food corresponding to the food identification code received by the food identification code input means.

26. A food storage apparatus according to claim 22, which is a refrigerator including a cold storage compartment in which the food is stored and refrigerating means for refrigerating an atmosphere in the cold storage compartment.

27. A method of managing food in a food storage apparatus, comprising:
inputting a food identification code affixed to food by means of food identification code input means;
accessing via a main data server to a global food data base by access means to download information about food corresponding to the food identification code;
accessing via a user data server to a local food data base by data control means to receive the food information; and
inputting by data control means the food identification code corresponding to the food stored in a storage compartment and managing the stored food on the basis of food information obtained by the access means and data control means.

28. A food managing method according to claim 27, further comprising:
storing, on a local food data base managing for every user, the information about the food to be managed;
accepting a requirement for access to a main data server and accessing via a public communication network to the main data server; and
accepting an access via a user communication network from the food storage apparatus or a food processor, and providing the information about the food in reply to a requirement for readout of the information about the food stored on the local food data base.

29. A food managing method according to claim 27, further comprising uploading the information about the food stored on the local food data base in reply to an access by a portable terminal unit.

30. A food managing method according to claim 27, further comprising:
receiving the food identification code delivered from a radio tag affixed to the food by the food identification code input means; and
accessing by the data control means to the local food data base to add to or delete from the data base the food corresponding to the food identification code received by the food identification code input means.

31. A food processor comprising:
food identification code input means for inputting a food identification code affixed to food;
access means f or accessing via a main data server to a global food data base and downloading information about food corresponding to the food identification code;
data control means for accessing via a user data server to a local food database to receive the information about the food; and
food processing control means for inputting the food identification code affixed to the food to be processed, by means of the food identification code input means and executing an automatic food processing on the basis of the information about processing obtained by the access means and the data control means.

32. A food processor according to claim 31, wherein the food identification code input means receives the food identification code delivered from the radio tag affixed to the food, and the data control means accesses to the local food data base to download the information about processing of the food and execute an automatic food processing on the basis of the information of processing of the food.

33. A food processor according to claim 31, wherein the food identification code input means receives the food identification code delivered from a radio tag affixed to the food, and the data control means accesses to the global food data base to download the information about processing of the food and execute an automatic food processing operation on the basis of the information about processing of the food.

34. A food processor according to claim 31, provided with a function of delivering, to the user data server, a requirement for deletion from the local food data base of the information about management of the food when the automatic food processing has been executed for the food.

35. A method of processing food by means of a food processor, comprising:
causing food identification code input means to input a food identification code affixed to food;
causing access means to access via a main data server to a global food data base to download information about food corresponding to the food identification code;
causing data control means to access via a user data server to a local food data base to receive the information about the food; and
causing the food identification code input means to input the food identification code affixed to the food stored in a food storage apparatus and managing the stored food on the basis of the information about the food obtained by the access means and the data control means.

36. A food processing method according to claim 35, further comprising:
causing the food identification code input means to receive the food identification code delivered from a radio tag affixed to the food; and
causing the data control means to access to the local food data base to download information about processing of the food corresponding to the food identification code received by the food identification code input means and executing an automatic food processing on the basis of the information about processing of the food.

37. A food processing method according to claim 35, further comprising:
causing the food identification code input means to receive the food identification code delivered from a radio tag affixed to the food; and
causing the data control means to access to the global food data base to download information about processing of the food corresponding to the food identification code received by the food identification code input means and executing an automatic food processing on the basis of the information about processing of the food.

38. A food processing method according to claim 35, further comprising delivering, to the user data server, a requirement for deletion from the local food data base of the information about management of the food when the automatic food processing has been executed for the food.

39. A portable terminal unit comprising:
communication means for accessing via a public communication network to a personal food management data base provided in a main data server and managed for every user; and
data control means for downloading information about food corresponding to a content of a local food data base stored on the personal food management data base.

40. A portable terminal unit comprising:
communication means for accessing via a user communication network to a local food data base provided in a user data server and managed for every user; and
data control means for downloading food information corresponding to a content of a local food data base stored on the local food data base.

41. A food management and processing method comprising:
storing on a global food data base information about food to be managed together with a food identification code for every food, the information about food including information about management of the food and information about processing of the food;
storing on a local food data base the information about the food managed for every user;
inputting the identification code affixed to the food in a food storage apparatus with a food managing function to download the information about the food corresponding to the food identification code via a public communication network from the global food data base and to download the information about the food via a user communication network from the local food data base; and
inputting the identification code affixed to the food to a food processor with an automatic food processing function to download the food information corresponding to the food identification code via the public communication network and to download the information about the food via the user communication network from the local food data base.

42. A food management and processing method according to claim 41, further comprising downloading the food information when a personal food management data base managed for every user and storing the information about the food corresponding to a content stored on the local food data base is accessed via the public communication network.

43. A food management and processing method according to claim 42, further comprising downloading the food information when the personal food management data base is accessed via the public communication network from a portable terminal unit.

44. A food management and processing method according to claim 41, further comprising downloading the food information when the local food data base is accessed via the user communication network from a portable terminal unit.
